(19) United States
(12) Patent Application Publication
(10) Pub. No.: US 2003/0210428 A1
(43) Pub. Date: Nov. 13, 2003

(54) Non-OCR method for capture of computer filled-in forms

(76) Inventors: Alex Bevlin, Santa Monica, CA (US); Alex Stein, Sherman Oaks, CA (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/223,913

(22) Filed: Aug. 20, 2002

Related U.S. Application Data
(60) Provisional application No. 60/378,707, filed on May 7, 2002.

(51) Int. Cl. G06F 15/00; G06F 7/00

(52) U.S. Cl. 358/1.18; 358/1.13

(57) ABSTRACT

A method for capturing content from a legacy data system. A print format language (PFL) file is generated by the legacy data system corresponding to a printed form or report. A corresponding PFL template is defined that is used delineate dynamic zones of the printed form or report from static areas, wherein the static areas contain content that is constant across multiple pages of forms (e.g., fixed graphical and formatting content and field titles) and the dynamic zones contain content that varies (e.g., field values). Through application of the template, the legacy system data are extracted from the PFL file. Portions of the extracted legacy system data corresponding to each of the plurality of fields of the legacy system form or report are determined and the data are provided to a new data system in a manner that relates each portion of the extracted legacy system data with the field which it corresponds.

### CLAIM OF PRIORITY

This application is related to, and hereby claims the benefit of the filing date under 35 U.S.C. §119(e) of co-pending provisional application serial No. 60/378,707, which was filed May 7, 2002.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2002, Exigen Group, All Rights Reserved.

### FIELD

The invention generally relates to transfer of data between incompatible data systems and the like, and in particular, to a non-OCR (optical character recognition) method for capturing computer filled-in forms to enable data transfer between the incompatible data systems.

### BACKGROUND

Oftentimes, organizations need to transfer data between incompatible data systems, such as a legacy system and a new system. (As used herein, the use of the term “legacy system” or “legacy data system” refers to any type of existing system that provides form-based output, such as forms and reports, and includes form issuance systems and applications as well as conventional data systems.) Typically, the legacy system and new systems will run on different platforms (hardware and/or operating systems), which leads to great difficulty in transferring the data between the systems. Furthermore, the storage schema used for the systems will also usually differ significantly.

In some of cases, conversion software must be specially written to “migrate” data between the legacy or form issuance system and new systems. This can be a daunting and very expensive task, and may not be possible under many conversions scenarios. A more simple way of transferring data between the systems involves the use of optical character recognition (OCR). Generally, data may be accessed in data systems via a set of printed forms. Accordingly, conversion from a legacy or form issuance system to a new system may be accomplished by graphically inputting printed forms containing legacy data via some mechanical method (e.g., scan, fax, etc.), create an optical character recognition (OCR) application to use OCR to capture the data, and enter the captured data into the new system.

For example, suppose it is desired to transfer data from a legacy or form issuance system data system 100 in FIG. 1 to a new data system 102. Legacy data stored in a legacy data system database 104 having a legacy schema is processed by a processor 106 using a filter 108 (i.e., one or more database queries) and a set of forms 110 to generate a print file 112. The print file is submitted to a printer 114 for printing, thereby producing printed forms 116, which comprise hard-copy output of the legacy system data. The legacy system data may then be extracted from the printed forms by scanning the forms with a scanner 118 and processing the scanned content using an OCR-based application 120 designed for processing data configured to correspond to the layout of printed forms 116, typically through use of an extraction template. The data produced by OCR-based application 120 are then processed by a conversion application 122 that stores processed data in a new data system database 124 having a database schema corresponding to the new system's data model.

Another example widely found in today's business environments is illustrated in FIG. 2. In the illustrated scheme, forms 130 produced by multiple distributed insurance or financial agencies (only one of which is shown) are submitted to a centralized site 132 for OCR-to-data conversion processing. Typically, the agencies will use different equipment and software to create and fill in different forms. Under the current art, the forms are delivered from the agencies to the central processing site through fax or hardcopy (printout). In some cases original files are delivered through email, FTP, etc. Upon arrival at centralized site 132, the forms are printed, scanned, and processed using an OCR-based application that employs various extraction templates retrieved from a template database 134. Various data extracted from the forms are then stored in a document database 136 and a legacy database 138.

In addition to using OCR, there are electronic means for capturing and storing legacy system data. For example, Computer Output to Laser Disk (COLD™) technology may be employed to store form content on laser disks. However, this technology is mainly used for archiving data from legacy systems, etc. COLD technology takes pure text from a legacy system and requires separate development of form-templates if form representation is needed. This is very expensive and time-consuming process, especially if dozens or hundreds of different types of forms must be processed. Special design skill is needed, and maintenance is very difficult as well. Finally, in many cases the new forms do not qualify as legal copy of the original forms.

The current practices described above are terribly inefficient, for multiple reasons:

1. Printer usage is abnormally high, thus requiring a correspondingly high level of maintenance, which is costly, consumes resources, and generates environmentally-damaging waste.

2. Printing such large volumes of paper is also wasteful, thus unnecessarily polluting the environment and consuming resources.

3. The mechanisms needed to read such large volumes of paper are expensive and also require maintenance and consume resources.

4. The accuracy of OCR technology for reading a document after scanning or faxing is usually not sufficient and requires auditing and manual intervention, which is costly and time-consuming.

5. In cases of distributed systems, the method of the current art can become very complicated, as print files can be very big, and in some cases fill a whole tape.

What is clearly needed is a better, less costly, more efficient, and cleaner method for transfer of forms (data+image) between incompatible systems, rather than being printed out, read in via some mechanical method, and processed by OCR. Further, a system and a method is needed to allow integration of forms (formatted data+image) from multiple systems in various different localities.

### SUMMARY

In accordance with aspects of the present invention, a method for capturing content from a legacy data system is disclosed. A print format language (PFL) file, such as a Hewlett-Packard PCL file, PostScript file, Adobe PDF file or the like is generated by the legacy data system or a third party application corresponding to a printed form or report. A corresponding PFL template is defined to delineate static and dynamic zones of the printed form or report, wherein the static zones contain content that is constant across multiple pages of forms (e.g., fixed text, graphical and formatting content, such as field titles) and the dynamic zones contain content that varies (e.g., field values). Through application of the template, the legacy system data are extracted from the PFL file. Portions of the extracted legacy system data corresponding to each of the plurality of fields of the legacy system form or report are determined and the data are provided to in a new data system in a manner that relates each portion of the extracted legacy system data with the field to which it corresponds.

According to one aspect of the invention, the static and dynamic zones are defined during a mapping process in which indicia identifying the location of each of a plurality of static and dynamic zones are stored in the PFL template, along with indicia identifying each zone. During processing of the PFL file, words are extracted from the PFL file, and the location of the words are identified to determine which static or dynamic zone they are contained in. The words inside a given zone are then arranged in phrases, and data corresponding to the phrases is provided to or stored in the new data system, along with the indicia identifying which zone the data were extracted from.

Accordingly to another aspect of the invention, graphic content in the original form or report may be extracted and stored in a manner that enables the new data system to reproduce the graphical content. In addition, the PFL template may be further employed to apply layout information in a form or report generated via the new data system to produce a replicate of a corresponding original form or report that might be generated from the legacy data system.

Other features and advantages of the present invention will be apparent from the accompanying drawings, and from the detailed description, that follows below.

### BRIEF DESCRIPTION OF THE DRAWINGS

Embodiments of the present invention are illustrated by way of example, and not limitation, by the figures of the accompanying drawings in which like references indicate similar elements and in which:

FIG. 1 is a schematic diagram illustrating a conventional data capture process that employs optical character recognition (OCR);

FIG. 2 is a schematic diagram illustrating a typical business environment in which forms are submitted from various locations to a central OCR processing site that is used to capture data from the forms using OCR;

FIG. 3 is a schematic diagram illustrating an overview of a data capture process in accordance with an embodiment of the invention;

FIG. 4 is a representation of an exemplary computer-entry form as might be used in a legacy data system;

FIG. 5 is a representation of a printed form corresponding to the computer-entry form of FIG. 4 that might be produced by the legacy data system via a print form or print report process;

FIG. 6A is a high-level block diagram illustrating the mapping and production phases employed by the non-OCR capture process of the present invention;

FIG. 6B is a flow process diagram illustrating details operations performed during the mapping and production phases;

FIG. 7A is a representation of a mapping application window including a virtual form via which a user is enabled to graphically define dynamic zone mappings;

FIG. 7B is a representation of the mapping application window of FIG. 7A after a user has defined the dynamic zone mappings for a given form;

FIG. 8 is a schematic diagram illustrating one embodiment employing a coordinate system to define the boundaries of the dynamic zones;

FIG. 9 is a process flow chart for a print operation in accordance with an embodiment of the invention; and

FIG. 10 is a schematic diagram of an exemplary computer server system that may be employed to practice the operations described in the embodiments of the invention disclosed herein.

### DETAILED DESCRIPTION

In the following detailed description of exemplary embodiments of the present invention, numerous specific details are set forth in order to provide a thorough understanding of the described embodiments of the present invention. However, it will be apparent to one skilled in the art that alternative embodiments of the present invention may be practiced without these specific details. In some instances, well-known structures and devices are shown in block diagram form, rather than in detail, in order to avoid obscuring the description of exemplary embodiments of the present invention.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

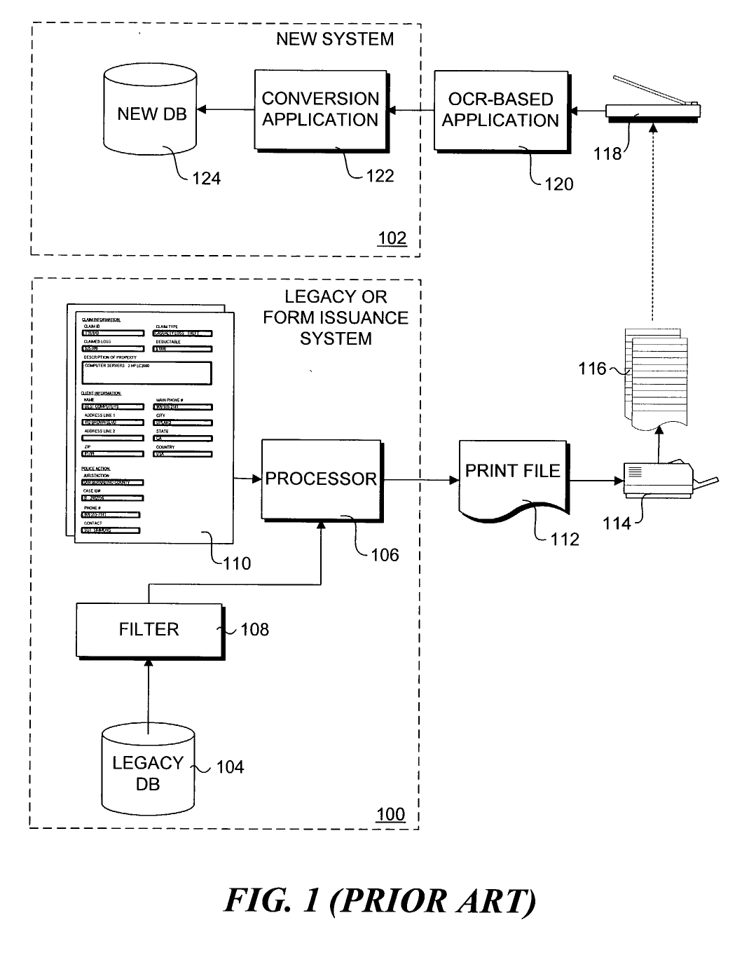

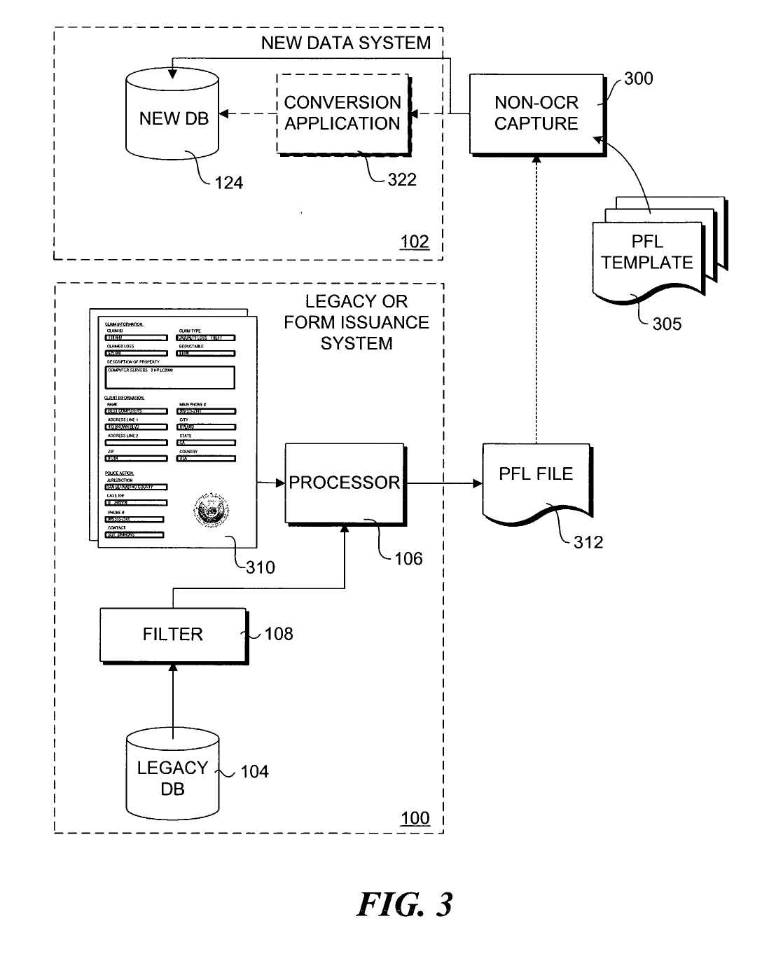

An overview of a system for capturing legacy system data via a non-OCR capture process is shown in FIG. 3. In accordance with an embodiment of the invention, the processing that occurs in the legacy data system is substantially similar to that described above with reference to the prior art system of FIG. 1, with the primary exception that legacy system forms 310 are now enabled to include graphic (when compared with legacy system forms 110). Additionally, print file 112 has been replaced with a form template Print Format Language (PFL) file 312 that may further contain renderable data pertaining to the graphic content in addition to the text and layout data present in print file 112, and has a format targeted for a PFL-compatible printer, as explained in further detail below.

Rather than submit form template PFL file 312 to a printer, scan the printed forms, and capture data using an OCR process, the form template PFL file is submitted directly to a non-OCR capture process 300 that extracts data, including text and graphical content, along with layout information contained in the form template PFL file using an appropriate PFL template selected from a set of PFL templates 305. Depending on the particular implementation, the non-OCR capture process may be used to directly store captured data in new data system database 124, or a conversion application 322 may be employed to assist in this process.

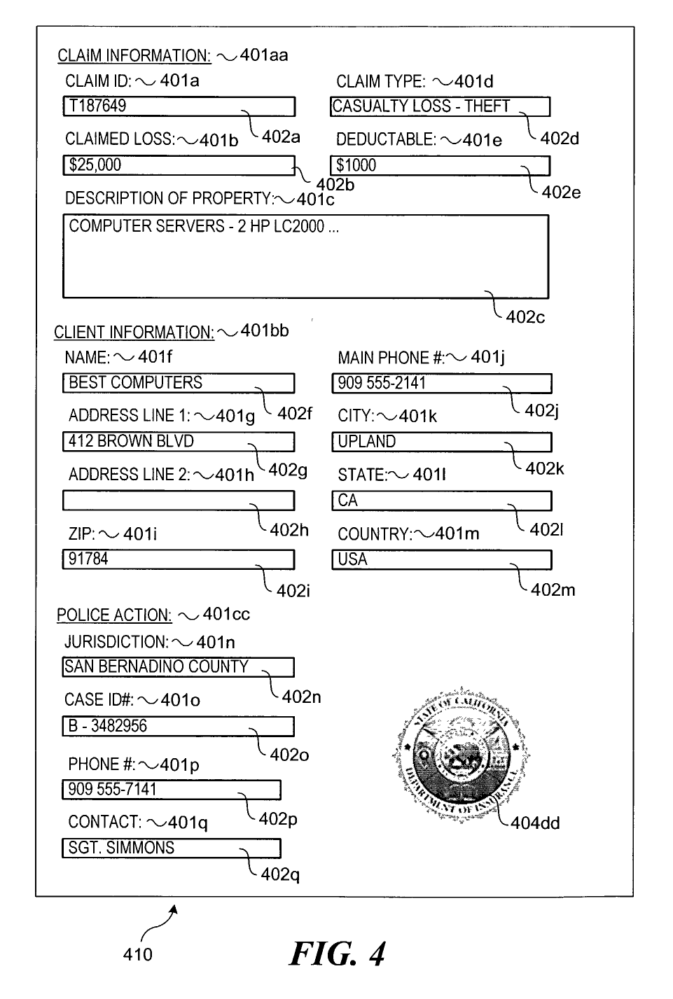

A representation of a typical computer entry form 310 as viewed during entry of data into a legacy data system is shown in FIG. 4. In this example, the computer entry form corresponds to a form that might be used for entering and viewing insurance claim information. As is common with many computer entry forms of this type, computer entry form 400 includes a plurality of field descriptors 401n displayed adjacent to respective entry boxes 402n in which field values corresponding to descriptors are entered and/or viewed. (As used herein, an italicized n is used in place of letters a, b, c, d, e, etc. that appear in the Figures). For example, field descriptors 401a-e displayed at the top of the form respectively include “CLAIM ID:”, “CLAIMED LOSS:”, “DESCRIPTION OF PROPERTY:”, “CLAIM TYPE:”, and “DEDUCTABLE:”, while each of corresponding entry boxes 402a-e is displayed below its respective field descriptor. In addition to field descriptors, many computer entry forms include section descriptors that are used to delineate section on the form, such as illustrated by section descriptors 403a, 403b, and 403c on computer entry form 400.

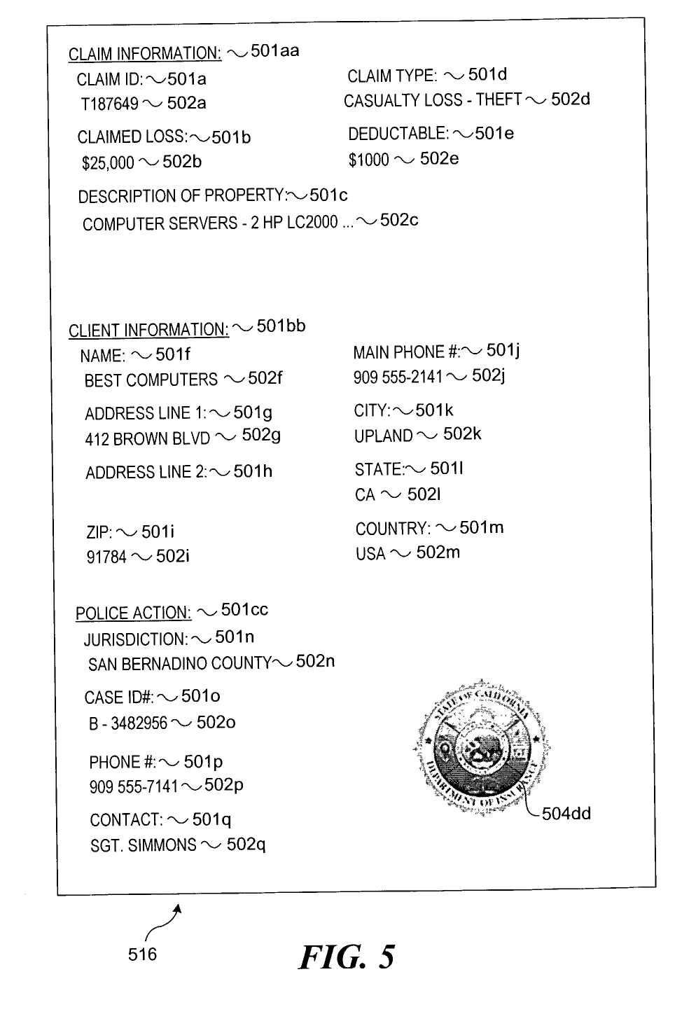

A printed form 516 corresponding to computer entry form 310 is shown in FIG. 5. In general, printed from 516 is representative of the hard copy output a PFL-compatible printer would produce if it was to render form template PFL file 312. In the illustrated embodiment, the textual content of the printed form mirrors the textual content of the computer entry form. For example, the printed form includes field descriptors 501n, which mirror field descriptors 401n in the computer entry form. Similarly, field values 502n mirror the field values entered in entry boxes 402n, respectively. Furthermore, the arrangement of the various text elements are substantially the same. One noticeable difference is that the field values in the printed form appear simply as text, without a surrounding box.

It is noted that the printed form may also differ from the computer entry form in the way field values are displayed. For example, while the computer entry form may include separate fields and corresponding field descriptors for entering address information, the printed form might include a full address comprising data from those same fields (e.g., Address Line 1, Address Line 2, City, State, Zip code, etc.) disposed adjacent a single “ADDRESS” field descriptor.

In general, printed forms that are generated using legacy system data will generally have a format similar to printed form 516, or may comprise tabulated lists. Typically, such printed forms may be generated on an individual basis, a batch basis, or through the use of a report script. For example, a legacy data system or other form issuance system may support printing single or multiple pages corresponding to a given individual or set of computer entry forms via a print option or the like. Optionally, the legacy data system (or a third party system that may access the legacy data system data) may provide a report building application that enables users to design report layout and contain via which printed forms may be generated. Tabulated lists are more common for reports, although reports may be designed to produce form-configured output as well.

In accordance with one aspect of the invention, the system not only captures text-based data from a legacy data system or other form issuance system, but captures graphical content and layout information as well. In view of this capability, computer entry form 310 and printed form 516 further include exemplary display and printed graphic elements 404dd and 504dd, respectively. The objective in this instance is to be able to produce a printed form via the new data system that is a substantially exact replication of a corresponding printed form that was or could have been previously generated by the legacy data system or other form issuance system. This replication capability is a vital element of the novel art disclosed herein, because prior art, such as, for example, COLD technology, may lose its standing as a legal document if it is “redesigned” such that it differs from the original.

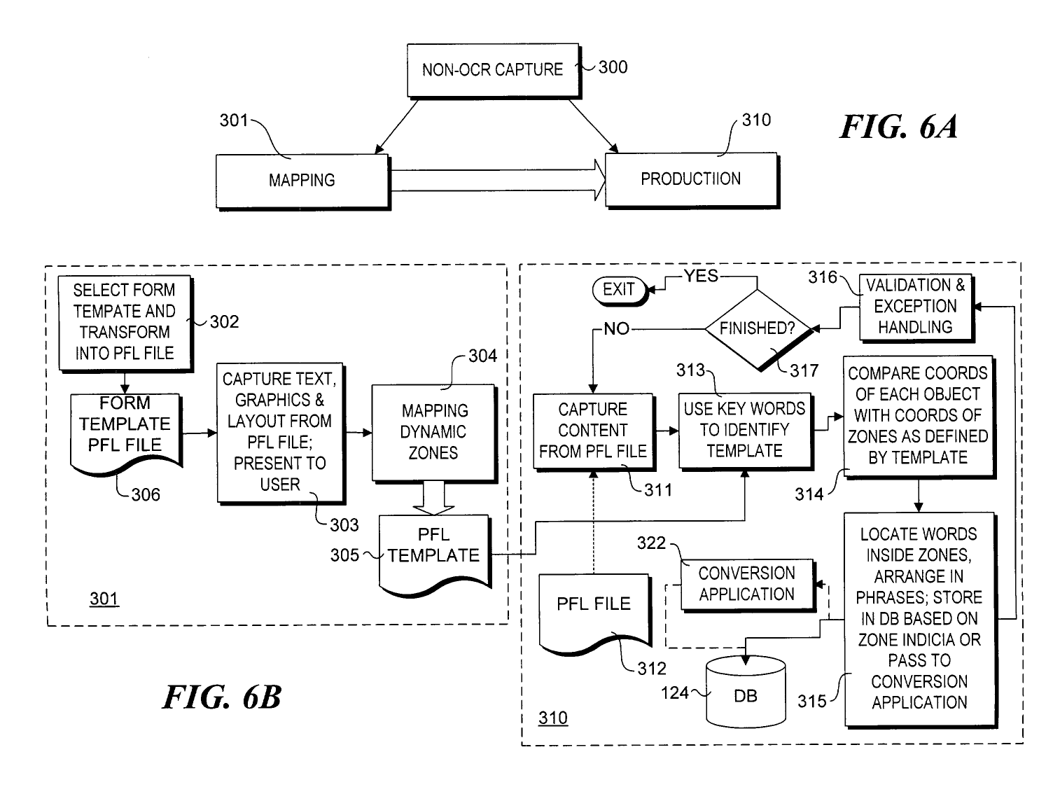

Further details of non-OCR capture process 300 are shown in FIGS. 6A and 6B. At a high level, non-OCR capture process 300 includes two main phases: a mapping phase 301 and a production phase 310. Typically, each new form is mapped only once, the first time it is introduced. For all subsequent uses of any specific form, the form map is retained as a template. Production refers to the processing of batches of forms 310. In many cases a set of different forms may be combined in one document represented by one PFL file. For example, the forms may be processed during hourly, daily, weekly, and/or monthly runs or processing can start from at moment the form becomes available for processing.

Mapping

Details of mapping phase 301 are illustrated in the left-hand portion of FIG. 6B. The process begins in a block 302, wherein each of the possible form templates is selected transformed into a corresponding from template PFL file 306. The most commonly used print languages are PCL (Printer Control Language, a print format language for Hewlett-Packard printers), PDF (Portable Document Format, a PFL for universal printing and display made by Adobe Corporation), or Postscript (PS). However, any of the many other existing print formats may be used, beyond these more generic print formats.

The most natural way to perform this operations is to create a PFL file corresponding to a form template from a legacy data system or other form issuance system, or a third party application that may be used to access the legacy data system. For example, a user might select a “Print to File” option available in the application. A print driver corresponding to the destination PFL file must be installed on the computer used to process the print request. For example, if one wished to produce a PFL file having a PCL format, the user would need to have an appropriate PCL-compatible print driver installed. In response to the “Print to File” request, the computer will generate a PFL file corresponding to the form template. Print invocation methods other the “Print to File” menu options and the like may also be used to create the PFL file.

Next, in a block 303, the text and graphic content of the form template PFL file are captured, along with the layout information, and presented to the user in a readable format. In one embodiment, this operation may be performed by a PFL-compatible reader, such as Adobe Acrobat (for PDF files) or a PostScript file reader. There are also a number of PCL viewers that may be used for rendering display images of PCL-formatted files.

In a block 304 mapping operations are performed to define dynamic portions (zones) of the printed form. The dynamic zones are areas on the printed form that may contain variable content (i.e., content that may differ on different forms). Typically, the dynamic zones will contain field values. It is further noted, that field values may include graphical content as well as textual content.

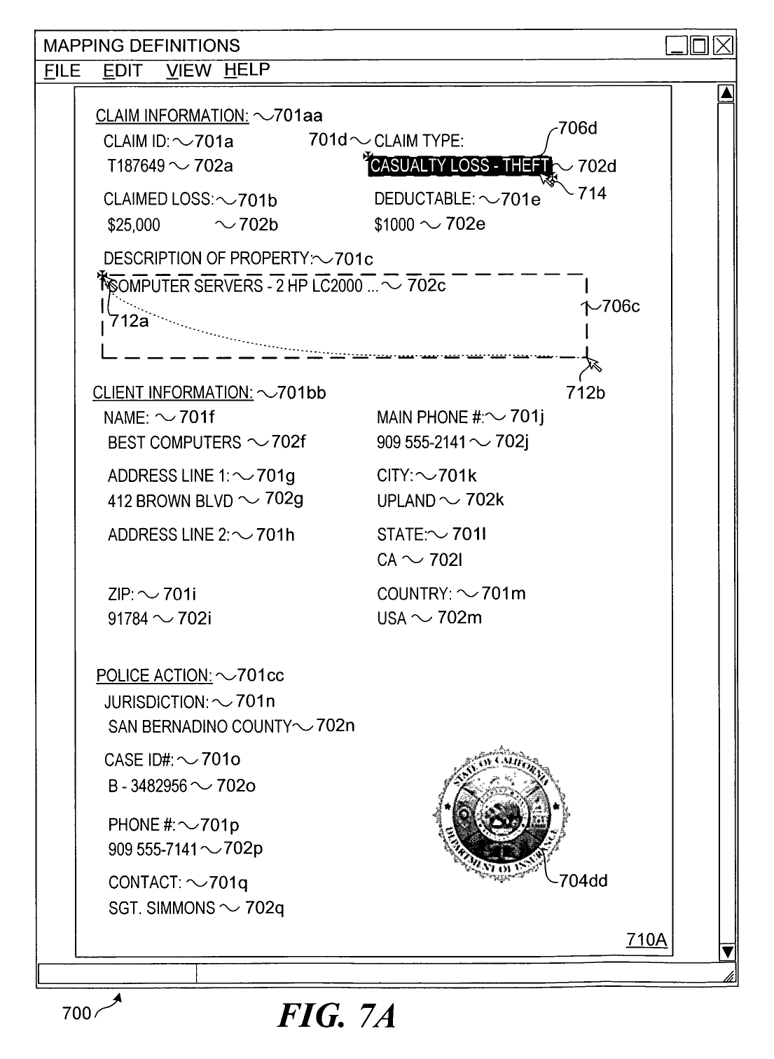

In one embodiment, users are enabled to define the dynamic zones via a mapping application in which a “virtual” form template 710 representative of a “to be printed” form is employed. For example, the application enables a user to select an area corresponding to a dynamic zone by clicking on a first corner of a “bounding” box defining the area with a cursor control device (e.g., mouse, trackball, etc.) and dragging the cursor to an opposite of the bounding box and then releasing the cursor, as depicted by cursors 712a and 712b, which are used to define a dynamic zone 706c in FIG. 7A. In one embodiment, the size of the bounding box may be automatically determined based on selected content. For example, the user could select the words “CASUALTY LOSS-THEFT” corresponding to field value 702d, as depicted by a cursor 714, and then perform an input device operation, such as double-clicking or right-clicking the cursor control device or selecting a menu option. In response, in one embodiment the mapping application would store coordinate data corresponding to a virtual bounding box that would encompass the selected text, wherein the coordinate data define a dynamic zone containing the selected text, such as depicted by a dynamic zone 706d. Generally, single-line and multiple-line fields may be defined in this manner.

In one embodiment, the form template may be generated that includes field values that occupy the maximum width of corresponding fields. For example, if a field is defined as varchar 32 (i.e., a 32-character maximum variable-width field), the field in the form template could be represented by 32 characters, such as X's. In other instances, the form template field may contain a value that occupies less than the maximum width of the field. In this instance, the application provides one or more mechanisms that allow that bounding coordinates to be adjusted. For example, in one embodiment the bounding coordinates are presented in a dialog, and may simply be edited manually by the user. In another embodiment, a bounding box corresponding to the bounding coordinates may be resized by selecting the box with the cursor and then dragging a selected side of the box.

Generally, indicia to identify each dynamic zone will also need to be defined. In forms in which there are respective field descriptors for each field (as defined by a corresponding dynamic zone), the respective field descriptors may be implied as the indicia to be used. In one embodiment, the user is enabled to enter indicia as each dynamic zone is defined, or selectively add such information at a subsequent point in time. Generally, the indicia may be used for storing data captured from the dynamic zones in a new data system, as described in further detail below. For example, the indicia may correspond to a new or existing column in a database table of the new data system

A virtual form template 710B having completely defined dynamic zone mappings is shown in FIG. 7B. In the Figure, dynamic zones 706n are defined by the bounding boxes with the large dashes. Upon having completed the mapping definitions, the user will activate a menu option or control to request that the mappings be saved to a PFL template 305. In one embodiment, the user will be presented with a dialog box or the like in which the user can enter information by which the PFL template may be identified, such as keywords, a form title, etc. Optionally, keywords and the like may be automatically extracted from text contained in the non-dynamic zone portions of the form template.

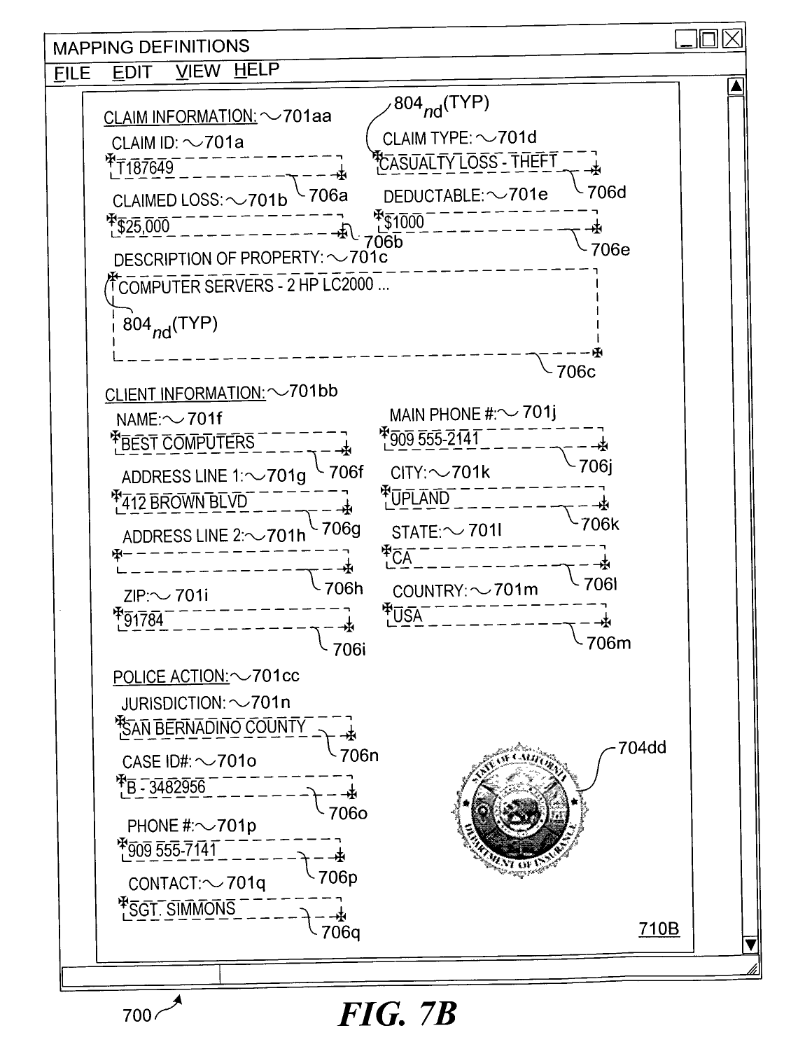

PFL template 305 comprises an augmented version of form template PFL file 306, wherein indicia defining the boundaries (e.g., corners or location and size of bounding box) of each dynamic zone are added to the file. Generally, the PFL files that are processed using the PFL template will contain layout information that is based on a primary datum, which will typically comprise either a corner of the printer paper, or a margin corner in the printed document, as indicated by a primary datum 800 in FIG. 8. The location of all content on the printed form is defined by indicia embedded in the PFL file. For example, such indicia might define the location of each word (most commonly used), a line of text, a phrase, a graphic object, etc. In some instances, the location of a printed object (text or graphic) may be dependant on the content of other objects in the printed form. For example, in the case of a paragraph, the location of each word in the paragraph will depend on the location of the starting point of the paragraph (typically defined), the font used, the paragraph line spacing, and the paragraph margins. All of this information is typically defined in a PFL file.

Thus, in order to define the location of each dynamic zone, indicia specifying the boundaries of those zones are included in the PFL template corresponding to the form from which corresponding data are to be extracted. In one embodiment illustrated in FIG. 8, coordinate information identifying the edges of the dynamic zones (relative to a primary datum) are stored in the PFL template. For example, the Top, Left, Bottom, and Right edge coordinates (relative to primary datum 800 in an XY coordinate system) may be stored, as depicted by coordinate sets {T_{nd}, L_{nd}, B_{nd}, R_{nd}}. Typically, the unit of measure for the coordinate system will match the unit of measure employed by the PFL file type, although this in not a requirement.

In another embodiment illustrated in FIG. 8, the boundaries of each dynamic zone are respectively defined by locations of datums 807_{nd} (n indicates the zone number, d indicates dynamic) in combination with respective width and height information for the bounding box. For example, the location of each zone datum 807_{nd}, which in the illustrated example corresponds to the upper left hand corner of each dynamic zone bounding box, may be defined by a vectors 808_{nd} from the primary datum to the zone datum. If a XY coordinate system is implemented and the primary datum is defined to have X and Y coordinate positions of 0 and 0, the vectors may simply be defined by the X and Y coordinate locations of the datums relative to the primary datum. For example, in FIG. 8, the XY coordinates for the dynamic datums 807_{nd} are labeled X_{nd} and Y_{nd}. Again, the unit of measure for the XY coordinate system will generally match the unit of measure employed by the PFL file type, although this in not a requirement.

In the vector embodiment, indicia corresponding to the size of each zone is also included in the PFL template. In general, this information may comprise width and height information for the dynamic zone bounding boxes, such as illustrated by dynamic zone width and height values W_{nd} and H_{nd}. Preferably, the unit of measure for the width and height will be the same as that used for the datum locations.

Production

Details of production phase 310 (FIG. 6A) are illustrated in the right-hand portion of FIG. 6B. In contrast to the operations performed during mapping phase 301, which are generally one-time administrative operations for each form template, the operations performed during production phase 310 are performed during each production run-time. During the production phase, PFL files 312 are processed. PFL files 312 will generally be generated by either the legacy data system or a third party application that may access the legacy data system or any other form issuance system, in a manner similar to producing form template PFL file 306; however, in this instance, the PFL file will typically comprising renderable content to produce multiple hard-copy forms. Oftentimes, the PFL file will be generated using a predefined report.

The processing of PFL file 312 begins in a block 311, wherein all applicable content is captured from the PFL file (i.e., content that would appear in the printed form, including text, graphics, and formatting content). In one embodiment, an appropriate PFL template form among a plurality of PFL templates 305 is identified using key words that are captured, as depicted by a block 313. In optional embodiments, other PFL template identification schemes may be employed, such as using a script for both producing and processing the PFL files, wherein appropriate PFL templates are specifically identified in the script.

Next, in a block 314, the coordinates of each word are compared with the coordinates of the dynamic zones, as defined in PFL template 305. The idea here is to identify which words are contained in each of the dynamic zones, by comparing the location of those words as they would appear on a printed form (that would be produced if the PFL file was submitted to a PFL-compatible printer for printing) with the location of the dynamic zones as defined by where their corresponding bounding boxes would appear on the printed form. In one embodiment, only content contained in dynamic zones need to be located. In a block 315, words inside each of the zones, as applicable, are located and arranged in phrases. Data corresponding to the phrases, which generally may include one or more words and/or numerical values, are then either stored in the new data system database 124, or provided to conversion application 322. Typically, when data are to be stored directly in the database, the database needs to include a database schema defining the structure of one or more tables in which the data are to be stored. Accordingly, each phrase that is to be stored needs to include indicia identifying a table and column that corresponding data are to be stored in. This is where the previously-defined dynamic zone indicia comes into play. By knowing what which dynamic zone the phrases are contained in, the system can determined what table and column to stored the data in. The operations for block 314 and 315 are repeated for each page of content included in the PFL file. The same PFL file can contain multiple types of different forms.

In cases in which the data are to be provided to conversion application 322, the data do not need to be formatted so specifically. Generally, the data may be passed to the conversion application in a more generalized form, such as a comma-delimited file. However, the data should be provided in a manner that enables the conversion application to identify each set of data (i.e., which field values apply to which fields).

In instances in which the dynamic zones include graphical content, data pertaining to that content may be stored in the database in various forms. In one embodiment, PFL content for rendering the content may be directly stored in the database or be provided to the conversion application for subsequent storage in the database. Optionally, the PFL content may be rendered and converted to another format from which the graphic may be substantially replicated that doesn't require as much storage space, such as converting renderable PFL content into compressed image format, such as GIF, JPEG, TIFF, or the like.

In a block 316, optional validation and exception handling operations may be performed. For example, a check to determine if the content of a PFL file matches the PFL template may be performed. In cases in which the PFL file contains data corresponding to only one form, the process is complete. If cases where the PFL file contains data corresponding to multiple forms, the foregoing operations, beginning with block 311 are repeated for each of those forms, as indicated by a decision block 317.

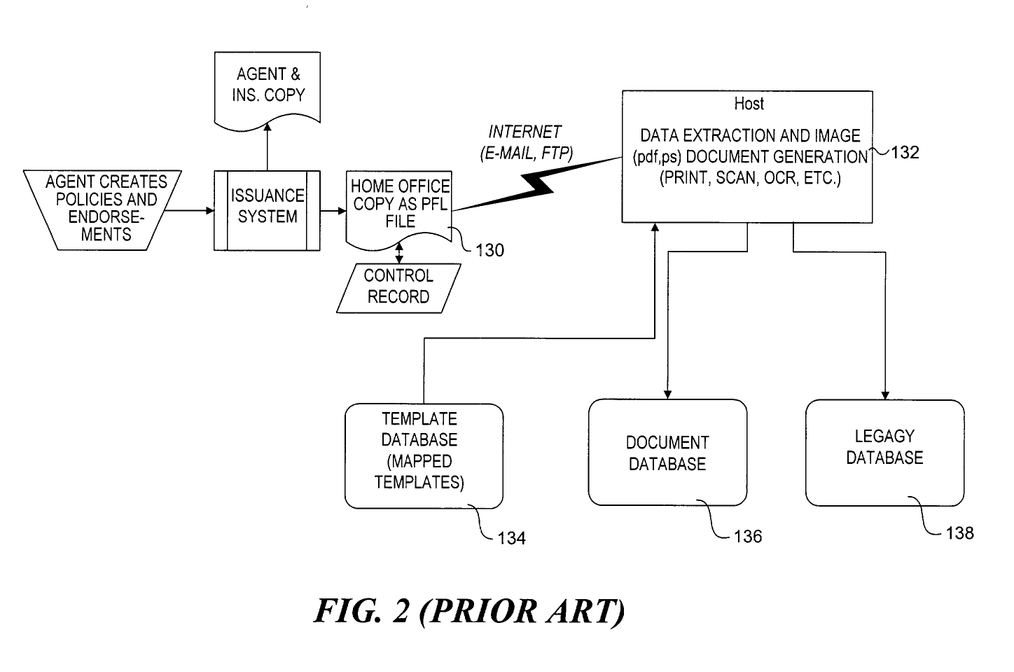

Forms for processing can arrive in batches, with many separate forms contained in one file. In some cases, each form is transmitted separately, rather than filling a big file. In some instances, forms may be e-mailed for processing (not shown), and in yet other cases, batches are FTPed between sites (also not shown), etc. In both situations, a form or a batch from one or more originating sites may be sent to one or more processing sites, thereby supporting a distributed environment similar to that shown in FIG. 2.

Replicating Original Forms

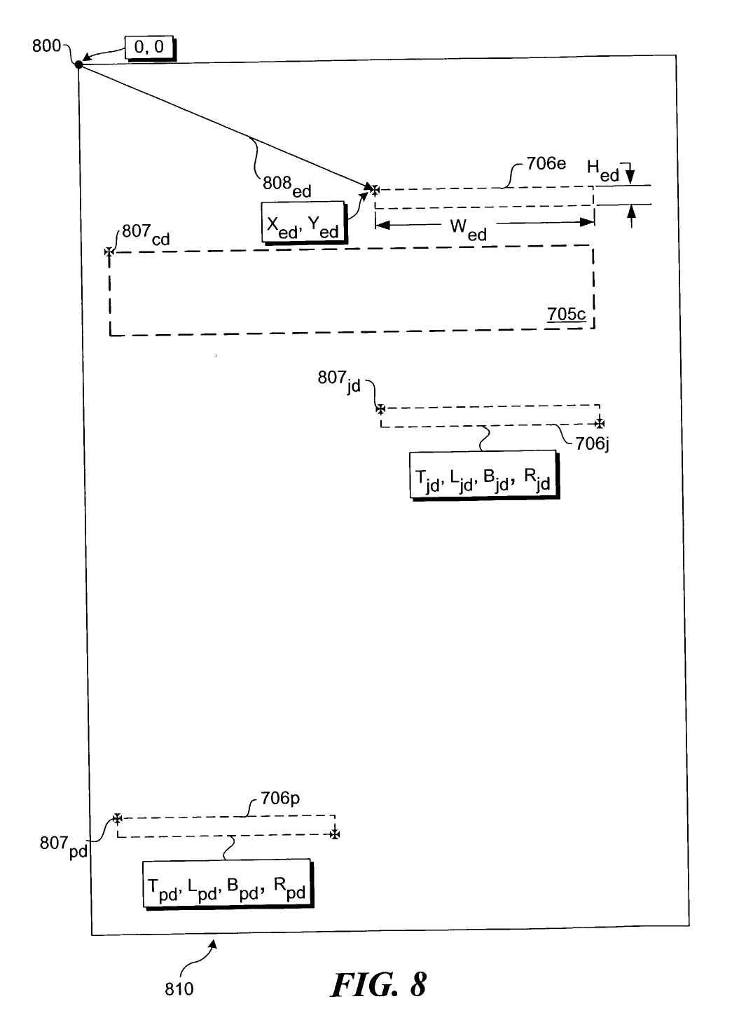

As discussed above, one aspect of the invention is the ability to replicate an original form via the new data system that may have been formerly produced (e.g., printed) by a legacy data system or form issuance system. With reference to FIG. 9, this is accomplished in a manner that somewhat parallels the content capture operations. In one embodiment, information may be included in PFL templates 305 comprising static PFL content corresponding to static (i.e., non-dynamic) portions of the original form. For example, such information could be used to render an original form without any filed values, wherein the content and layout of the original form are maintained. Furthermore, the PFL template for a given form contains indicia defining the location of the dynamic zones for that form, and further includes indicia identifying each dynamic zone. Collectively, this information may be used to define a set of dynamic zone “slots” in the PFL template that may be filled with corresponding field values, as appropriate. In is noted that in one embodiment PFL content corresponding to the static content and layout information corresponding to an original form may be stored in a separate output template 905A, while in another embodiment such information is stored in a modified PFL template 905B.

The output process begins in a block 900, these dynamic zone slots are filed with corresponding field values 902, which are retrieved from new data system database 124 using an appropriate database query (or set of queries). Generally, the data values may be inserted inline in the “slots” for the template.

Depending on the particular implementation and PFL format used, it may be necessary to strip out zone location and identification indicia from the PFL template, or otherwise disable such information. This can be done using various schemes. For example, if the indicia are contained in the header, they may be removed or commented out. Under another scheme, the process may start with a modified PFL template 905 in which all or a portion of the indicia was already removed.

The end result of the operations of blocks 900 and 908 is a PFL renderable 906, which can be rendered on a display 913 to produce viewable forms 914 or submitted to a printer 915 to produce printed forms 916. Notably, since the original forms' static content and layout information is already included in the PFL template (305 or 905B) and/or output template 905A, and the PFL templates were built using corresponding legacy data system content and layout information, the static content and layout in the output forms will be identical to that found in corresponding forms produced by the legacy data system. Furthermore, for a given set of dynamic zone content (i.e., field values) that match corresponding content in an original legacy data system-generated form, display forms 914 and printed forms 916 will comprise a substantially exact replication of that original form.

Exemplary File Server Computer System

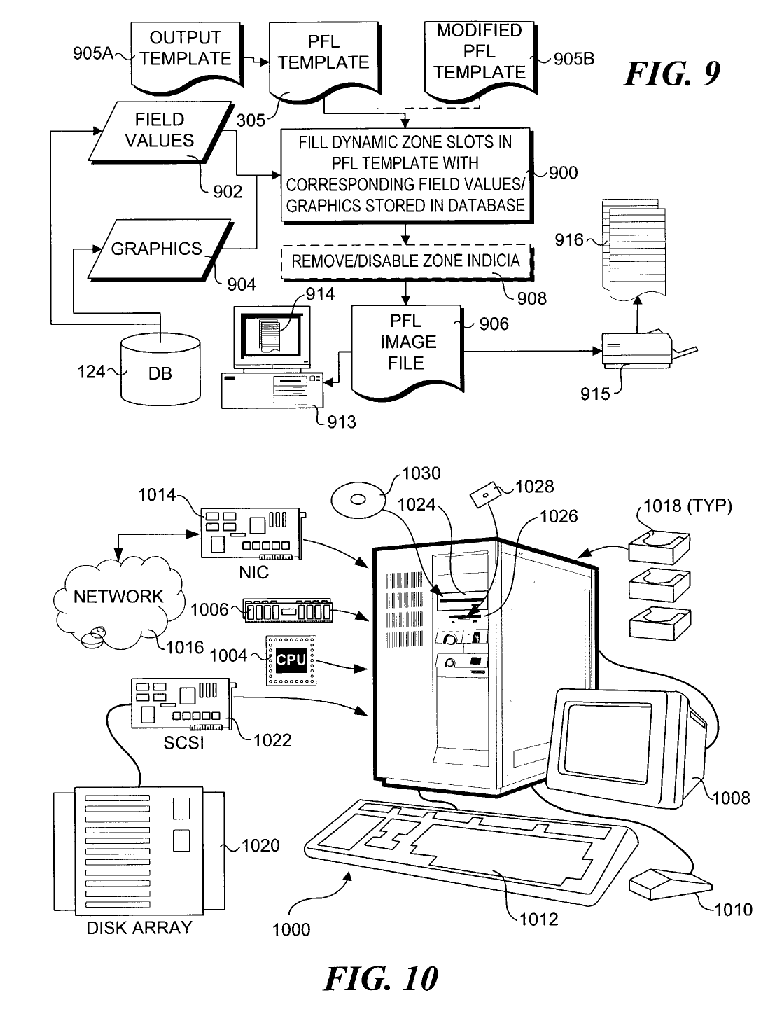

With reference to FIG. 10, a generally conventional computer server 1000 is illustrated, which is suitable for use in connection with practicing operations of the embodiments of the present invention described above. Examples of computer systems that may be suitable for these purposes include stand-alone and enterprise-class servers operating UNIX-based, Windows NT, Windows 2000 LINUX-based operating systems, etc.

Computer server 1000 includes a chassis 1002 in which is mounted a motherboard (not shown) populated with appropriate integrated circuits, including one or more processors 1004 and memory (e.g., DIMMs or SIMMs) 1006, as is generally well known to those of ordinary skill in the art. A monitor 1008 is included for displaying graphics and text generated by software programs and program modules that are run by the computer server. A mouse 1010 (or other pointing device) may be connected to a serial port (or to a bus port or USB port) on the rear of chassis 1002, and signals from mouse 1010 are conveyed to the motherboard to control a cursor on the display and to select text, menu options, and graphic components displayed on monitor 1008 by software programs and modules executing on the computer. In addition, a keyboard 1012 is coupled to the motherboard for user entry of text and commands that affect the running of software programs executing on the computer. Computer server 1000 also includes a network interface card (NIC) 1014, or equivalent circuitry built into the motherboard to enable the server to send and receive data via a network 1016.

File system storage corresponding may be implemented via one or more hard disks 1018 that are stored internally within chassis 1002, and/or via a plurality of hard disks that are stored in an external disk array 1020 that may be accessed via a SCSI card 1022 or equivalent SCSI circuitry built into the motherboard. Optionally, disk array 1020 may be accessed using a Fibre Channel link using an appropriate Fibre Channel interface card (not shown) or built-in circuitry.

Computer server 1000 generally may include a compact disk-read only memory (CD-ROM) drive 1024 into which a CD-ROM disk may be inserted so that executable files and data on the disk can be read for transfer into memory 1006 and/or into storage on hard disk 1018. Similarly, a floppy drive 1026 may be provided for such purposes. Other mass memory storage devices such as an optical recorded medium or DVD drive may also be included. The instructions comprising the software program and/or modules that cause processor(s) 1004 to implement the operations of the present invention that have been discussed above will typically be distributed on floppy disks 1028 or CD-ROMs 230 (or other memory media) and stored in one or more hard disks 1018 until loaded into memory 1006 for execution by processor(s) 1004. Optionally, the instructions may be contained in a carrier wave file that is loaded via network 1016.

In the foregoing specification, the invention has been described with reference to specific exemplary embodiment thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method for capturing content from a legacy data system, comprising:
generating a print format language (PFL) file comprising renderable content that if submitted to a PFL compatible printer will produce at least one printed form comprising a plurality of fields containing legacy system data and having a layout defined by one of a legacy data system form or report;
extracting the legacy system data from the PFL file;
determining portions of the extracted legacy system data corresponding to each of the plurality of fields of the legacy system form or report; and
providing the extracted legacy system data to a new data system in a manner that relates each portion of the extracted legacy system data with the field to which it corresponds.

2. The method of claim 1, wherein the legacy system data are extracted and the portions of the legacy system data corresponding to each of the plurality of fields are determined by performing the operations of:
defining a PFL template comprising a plurality of indicia via which the portions of the legacy system data contained in the PFL file corresponding to each of the plurality of fields may be identified; and
parsing the PFL file in view of the PFL template to extract the portions of the legacy system data corresponding to each of the plurality of fields.

3. The method of claim 2, further comprising:
defining a plurality of PFL templates, each to be applied to a respective form or report; and
determining at run-time which template from among said plurality of templates to apply to a given form or report.

4. The method of claim 2, further comprising:
mapping areas of a virtual form template representative of how data is to appear on corresponding printed forms into dynamic zones containing variable content that may differ on different printed forms; and
adding indicia to the PFL template defining boundaries for each area corresponding to dynamic zones.

5. The method of claim 4, wherein the indicia comprise coordinates identifying a location of each of the dynamic zones on the virtual form.

6. The method of claim 4, further comprising adding indicia identifying content to be contained in each dynamic zone to the PFL template.

7. The method of claim 4, wherein the variable content include graphical content, further comprising storing data corresponding to the graphical content in the new data system along with indicia identifying a dynamic zone to which the graphical content corresponds.

8. The method of claim 4, further comprising:
extracting words located in each of the dynamic zones from the PFL file;
arranging the words into phrases; and
storing data corresponding to the phrases in the new data system in a manner in which the dynamic zone from which each phrase was extracted may be identified.

9. The method of claim 1, further comprising employing the PFL template to generate a replicated form via the new data system, said replicated form having text and/or graphical content corresponding to an original form generated by the legacy data system.

10. The method of claim 9, wherein the replicated form is output via a printer to produce a hard copy of the original form.

11. A machine-readable media having instructions stored thereon, which when executed enable content to be captured from a legacy data system by performing the operations of:
extracting legacy system data from a print format language (PFL) file comprising renderable content to render at least one form comprising a plurality of fields containing the legacy system data and having a layout defined by one of a legacy data system form or report;
determining portions of the extracted legacy system data corresponding to each of the plurality of fields of the legacy system form or report; and
providing the extracted legacy system data to a new data system in a manner that relates each portion of the extracted legacy system data with the field to which it corresponds.

12. The machine-readable media of claim 11, wherein execution of the instructions extracts the legacy system data and determines the portions of the legacy system data corresponding to each of the plurality of fields by performing the operation of parsing the PFL file in view of a PFL template to extract the portions of the legacy system data corresponding to each of the plurality of fields; said PFL template comprising a plurality of indicia via which the portions of the legacy system data contained in the PFL file corresponding to each of the plurality of fields may be identified;.

13. The machine-readable media of claim 12, wherein a plurality of PFL templates are defined prior to a run-time operation, each to be applied to a respective form or report, and wherein execution of the instructions further performs the operation of determining during the run-time operation which template from among said plurality of templates to apply to a given form or report.

14. The machine-readable media of claim 12, wherein the PFL template includes indicia defining boundaries of dynamic zones containing variable content that may differ on different printed forms, and wherein execution of the instructions further performs the operation of storing data corresponding to the variable content in the new data system along with indicia identifying a dynamic zone to which the variable content corresponds.

15. The machine-readable media of claim 14, wherein execution of the instructions further performs the operation of enabling a user to define dynamic zones via a virtual representation of the legacy data system form or report.

16. The machine-readable media of claim 14, wherein the user is enabled to define dynamic zones by selecting content on the virtual representation of the legacy data system form or report.

17. The machine-readable media of claim 14, wherein the variable content comprises graphical content.

18. The machine-readable media of claim 16, wherein the data corresponding to the graphical content comprises PFL-formatted data via which the graphical content may be directly rendered on a PFL compatible device.

19. The machine-readable media of claim 14, wherein execution of the instructions further performs the operations of:
extracting words located in each of the dynamic zones from the PFL file;
arranging the words into phrases; and
storing data corresponding to the phrases in the new data system in a manner in which the dynamic zone from which each phrase was extracted may be identified.

20. The machine-readable media of claim 11, wherein execution of the instructions further performs the operation of employing the PFL template to generate an image file via which a form may be produced containing data retrieved from the new data system and having text and/or graphical content corresponding to an original form or report generated by the legacy data system.
